(19) United States
(12) Patent Application Publication
(10) Pub. No.: US 2025/0192228 A1
(43) Pub. Date: Jun. 12, 2025

(54) Lithium Secondary Battery

(71) Applicant: LG Energy Solution, Ltd, Seoul (KR)

(72) Inventor: Jeong Woo Oh

(73) Assignee: Daegu Gyeongbuk Institute Of Science And Technology, LDaegu (KR)

(21) Appl. No.: 18/702,074

(22) PCT Filed: Nov. 2, 2022
(86) PCT No.: PCT/KR2022/017011

§ 371 Date: Apr. 17, 2024

(30) Foreign Application Priority Data
Nov. 11, 2021 (KR) 10-2021-0154694

(51) Int. Cl. H01M 10/0567; H01M 4/02; H01M 4/525; H01M 10/052

(52) U.S. Cl. CPC H01M 10/0567; H01M 4/525; H01M 10/052; H01M 2004/028

(57) ABSTRACT

A lithium secondary battery has a non-aqueous electrolyte solution containing a lithium salt, an organic solvent, a first additive represented by Formula 1, and a second additive represented by Formula 2; a positive electrode including a positive electrode active material containing a lithium composite transition metal oxide including nickel, cobalt, and manganese; a negative electrode including a negative electrode active material; and a separator interposed between the positive electrode and the negative electrode:

LiSO₃R [Formula 1]

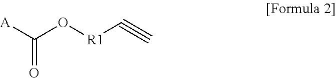

wherein R, A and R1 are described herein.

### CROSS-REFERENCE TO RELATED APPLICATIONS

This application is a national stage entry under 35 U.S.C. § 371 of International Application No. PCT/KR2022/017011 filed on Nov. 2, 2022, which claims priority from Korean Patent Application No. 10-2021-0154694 filed on Nov. 11, 2021, all the disclosures of which are incorporated by reference herein.

### TECHNICAL FIELD

The present disclosure relates to a lithium secondary battery including an electrolyte solution containing a specific additive combination and a high-nickel positive electrode material.

### BACKGROUND ART

A lithium secondary battery is generally prepared by a method in which, after an electrode assembly is formed by interposing a separator between a positive electrode including a positive electrode active material formed of a transition metal oxide containing lithium, and a negative electrode including a negative electrode active material capable of storing lithium ions, the electrode assembly is inserted into a battery case, a non-aqueous electrolyte solution, which becomes a medium for transferring the lithium ions, is injected thereinto, and the battery case is then sealed.

Lithium secondary batteries can be miniaturized and have high energy density and operating voltage, and thus have been applied to various fields such as mobile devices, electronic products, and electric vehicles. In particular, a low-cost high-energy positive electrode material is essential to be applied to medium and large sized devices such as an electric vehicle and a power storage system, and LiCoO₂ having a high operating voltage and excellent capacity characteristics has a disadvantage that the thermal stability thereof is not good and the price is high.

Therefore, nickel cobalt manganese-based lithium composite transition metal oxide (hereinafter, simply referred to as “NCM-based lithium composite transition metal oxide”) is mainly used as a positive electrode material capable of replacing LiCoO₂, and the NCM-based lithium composite transition metal oxide has an advantage of relatively low price and high reversible capacity. However, when a nickel content is increased in the NCM-based lithium composite transition metal oxide for achieving high capacity, the surface stability deteriorates and the decomposition reaction of the electrolyte is intensified, thereby increasing the resistance of the battery and deteriorating life characteristics.

Therefore, there is a need to develop a method capable of improving these limitations.

### Technical Problem

An aspect of the present invention improves high-temperature life characteristics of a lithium secondary battery including an NCM-based positive electrode active material by introducing a non-aqueous electrolyte solution containing a combination of two specific additive.

Another aspect of the present invention provides a lithium secondary battery having improved quick charging performance by effectively solving the problem of SEI film decomposition of the lithium secondary battery including a silicon-based negative electrode material through the non-aqueous electrolyte solution.

### Technical Solution

According to an aspect of the present invention, there is provided a lithium secondary battery including:
a non-aqueous electrolyte solution containing a lithium salt, an organic solvent, a first additive represented by Formula 1 below, and a second additive represented by Formula 2 below;
a positive electrode including a positive electrode active material containing a lithium composite transition metal oxide including nickel, cobalt, and manganese;
a negative electrode including a negative electrode active material; and
a separator interposed between the positive electrode and the negative electrode.

LiSO₃R [Formula 1]

In Formula 1 above,
R is an alkyl group having 1 to 10 carbon atoms and being unsubstituted or substituted with fluorine, and

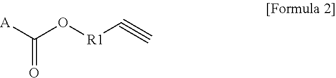

wherein, in Formula 2 above,
A is a heterocyclic group having 3 to 5 carbon atoms, or a heteroaryl group having 3 to 5 carbon atoms, and
R1 is an alkylene group having 1 to 3 carbon atoms.

### Advantageous Effects

The lithium secondary battery according to the present disclosure can improve life characteristics and quick charging performance of the lithium secondary battery including an NCM-based positive electrode active material and/or a Si-based negative electrode active material by including a non-aqueous electrolyte containing a specific additive combination.

### DETAILED DESCRIPTION

Hereinafter, the present disclosure will be described in more detail.

In general, an anion included in a lithium salt such as LiPF₆, which is widely used in an electrolyte solution for a lithium secondary battery, forms decomposition products such as hydrogen fluoride (HF) and PF₅ by thermal decomposition or moisture. These decomposition products have acidic properties and deteriorate the film or electrode surface in the battery.

Transition metals in the positive electrode are easily eluted into the electrolyte solution due to decomposition products of the electrolyte solution, structural changes of the positive electrode due to repeated charging and discharging, or the like, and the eluted transition metals are re-deposited on the positive electrode to increase the resistance of the positive electrode. In addition, when the eluted transition metals move to the negative electrode through the electrolyte solution, the eluted transition metals are electrodeposited on the negative electrode, causing destruction of a solid electrolyte interphase (SEI) film and additional electrolyte solution decomposition reaction, thereby causing limitations such as consumption of lithium ions and increase of resistance.

In addition, when the battery is initially activated, a protective film is formed on each of the positive electrode and the negative electrode by a reaction of the electrolyte solution, and when the film becomes unstable due to the above-described reason, additional electrolyte decomposition occurs during charging and discharging or high-temperature exposure, thereby promoting degradation of the battery and generating gas.

In particular, in the case of a battery including a positive electrode active material having a high nickel content, the initial capacity characteristics may be improved, but when charging and discharging are repeated, the amount of lithium by-products and gas generated may be increased due to side reactions, and the decomposition reaction of the electrolyte solution may be intensified.

In order to solve such a limitation, the present inventors have found that a first additive represented by Formula 1 below and a second additive represented by Formula 2 below are included in a non-aqueous electrolyte solution, and since this has an effect of forming an organic/inorganic composite SEI film on the electrode, the film is maintained in a more stable form, thereby preventing the decomposition reaction of the electrolyte solution from being intensified.

Hereinafter, each component constituting the present disclosure will be described in more detail.

### Non-Aqueous Electrolyte Solution

The lithium secondary battery according to the present disclosure includes a non-aqueous electrolyte solution containing a lithium salt, an organic solvent, a first additive represented by Formula 1 below, and a second additive represented by Formula 2 below.

Hereinafter, each component of the non-aqueous electrolyte solution will be described in detail.

### (1) First Additive and Second Additive

According to one aspect, the non-aqueous electrolyte solution of the present invention contains a first additive represented by Formula 1 below:

LiSO₃R [Formula 1]

In Formula 1 above,
R is an alkyl group having 1 to 10 carbon atoms and being unsubstituted or substituted with fluorine.

In an embodiment of the present invention, R in Formula 1 above is CₙF₂ₙ₊₁, wherein n may be any one integer of 1 to 5, preferably, 1 or 4. That is, the first additive may be LiSO₃CF₃ or LiSO₃C₄F₉.

The first additive contains a lithium ion, SO₃, and CₙF₂ₙ₊₁ in the structure thereof, and is thus stable and has an effect of forming an SEI film favorable for transferring lithium ions. Specifically, SO₃ has a low binding energy with a lithium ion, so that the lithium ion may be easily decoupled, and CₙF₂ₙ₊₁ contributes to forming a film of LiF component.

In an embodiment of the present invention, the content of the first additive may be 0.1 wt % to 5 wt %, preferably, 0.5 wt % to 3 wt % based on the total weight of the non-aqueous electrolyte solution. In consideration of the solubility of the solvent and the viscosity of the electrolyte solution after the additive is added, the content of the first additive is preferably 5 wt % or less.

Specifically, if the first additive is LiSO₃CₙF₂ₙ₊₁ and n is an integer of 3 or less, the content of the first additive is preferably 2 wt % to 4 wt % based on the total weight of the non-aqueous electrolyte solution, and if n is an integer of 4 or greater, the content of the first additive is preferably 0.1 wt % to 1 wt % based on the total weight of the non-aqueous electrolyte solution. Since the solubility varies with n, the optimal content range is different.

In addition, in one embodiment, the non-aqueous electrolyte solution of the present invention contains a second additive represented by Formula 2 below:

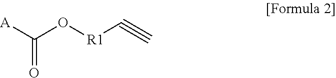

In Formula 2 above,
A is a heterocyclic group having 3 to 5 carbon atoms, or a heteroaryl group having 3 to 5 carbon atoms, and
R1 is an alkylene group having 1 to 3 carbon atoms.

Since the second additive represented by Formula 2 above contains a propargyl functional group, an SEI film having high passivation ability is formed on the surface of the negative electrode while the functional group is reduction-decomposed, and thus, high-temperature durability of the negative electrode itself may not only be improved, but electrodeposition of transition metals on the surface of the negative electrode may also be prevented. Also, the second additive may function to make it difficult to dissolve impurities by being adsorbed on the surface of the metallic impurities included in the positive electrode due to the propargyl group, and, accordingly, an internal short circuit, which may occur by precipitation of the dissolved metal ions on the negative electrode, may be suppressed. In addition, the generation of HF in combination with PF₅, which is a decomposition product of the electrolyte solution, is suppressed, so that it is possible to prevent the destruction of a cathode electrolyte interphase (CEI) film formed on the surface of the positive electrode due to the first additive and suppress the additional decomposition of the electrolyte solution.

That is, if the non-aqueous electrolyte solution of the present disclosure is used, a film of LiF and LiSO₃F components based on an inorganic material may be formed due to the first additive, and simultaneously, a film of stable organic material components capable of entirely covering the surface of the negative electrode active material may be formed due to the propargyl functional group in the second additive. In particular, the phenomenon of the formation of an unstable SEI film is intensified when a silicon-based negative electrode material is used. When the electrolyte solution of the present disclosure is applied, a more stable organic/inorganic composite film is formed, and thus it is possible to suppress the decomposition reaction of the electrolyte solution which is intensified when a positive electrode material having a high nickel content is used, so that it is also possible to effectively prevent the degradation of the negative electrode.

In an embodiment of the present invention, A in Formula 2 above may be a nitrogen-containing heteroaryl group having 3 to 5 carbon atoms, and preferably Formula 2 may be represented by Formula 2-1 below:

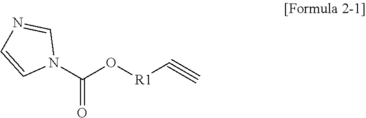

In Formula 2-1 above,
R1 is the same as defined in Formula 2 above.

In an embodiment of the present invention, R1 in Formula 2 above may be a linear or branched alkylene group having 1 to 3 carbon atoms, preferably, a linear alkylene group having 1 to 3 carbon atoms, more preferably, a methylene group.

In an embodiment of the present invention, the second additive may be represented by Formula 2A below:

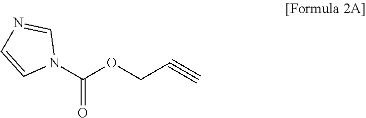

In an embodiment of the present invention, the content of the second additive may be 0.01 wt % to 2 wt %, preferably 0.05 wt % to 1 wt %, and more preferably 0.1 wt % to 0.5 wt % based on the total weight of the non-aqueous electrolyte solution. It is preferable that the content of the second additive is 2 wt % or less in terms of lowering the initial resistance.

### (2) Third Additive and Fourth Additive

In an embodiment of the present invention, the non-aqueous electrolyte solution may further include at least one third additive selected from among vinylene carbonate (VC) or vinyl ethylene carbonate (VEC). In this case, when the second additive is reduction-decomposed in the negative electrode, propargyl radicals attack the VC or VEC double bond, and thus a polymerization reaction is easily generated, thereby more quickly and effectively covering the surface of the active material when the organic material film is formed on the negative electrode.

In an embodiment of the present invention, the content of the third additive may be 0.01 wt % to 3 wt %, preferably 0.05 wt % to 2 wt %, and more preferably 0.1 wt % to 1 wt % based on the total weight of the non-aqueous electrolyte solution. It is preferable that the content of the second additive is 3 wt % or less in terms of lowering the initial resistance.

In addition, in one embodiment, the non-aqueous electrolyte solution of the present invention may further include the following additives as a fourth additive, as necessary, in order to prevent the electrolyte solution from being decomposed in a high-voltage environment to cause collapse of an electrode, or further improve low-temperature high-rate discharge characteristics, high-temperature stability, overcharge protection, and a battery swelling suppression effect at high temperatures.

The fourth additive may be at least one selected from among a halogen-substituted carbonate-based compound, a sultone-based compound, a sulfate-based compound, a phosphate-based or phosphite-based compound, a nitrile-based compound, an amine-based compound, a silane-based compound, a benzene-based compound, or a lithium salt-based compound.

The halogen-substituted carbonate-based compound may be fluoroethylene carbonate (FEC).

The sultone-based compound is a material capable of forming a stable solid electrolyte interphase (SEI) on a surface of a negative electrode by a reduction reaction, wherein the sultone-based compound may be at least one compound selected from 1,3-propane sultone (PS), 1,4-butane sultone, ethane sultone, 1,3-propene sultone (PRS), 1,4-butene sultone, or 1-methyl-1,3-propene sultone, and may specifically be 1,3-propane sultone (PS).

The sulfate-based compound is a material capable of forming a stable SEI film that does not crack even during high-temperature storage by being electrically decomposed on the surface of the negative electrode, wherein the sulfate-based compound may be at least one selected from among ethylene sulfate (Esa), trimethylene sulfate (TMS), or methyl trimethylene sulfate (MTMS).

The phosphate-based compound or the phosphite-based compound may be at least one selected from among lithium difluoro(bisoxalato)phosphate, lithium difluorophosphate, tris(trimethylsilyl)phosphate, tris(trimethylsilyl)phosphite, tris(2,2,2-trifluoroethyl)phosphate, or tris(trifluoroethyl)phosphite.

The nitrile-based compound may be at least one selected from among succinonitrile (SN), adiponitrile (ADN), acetonitrile, propionitrile, butyronitrile, valeronitrile, caprylonitrile, heptanenitrile, cyclopentane carbonitrile, cyclohexane carbonitrile, 2-fluorobenzonitrile, 4-fluorobenzonitrile, difluorobenzonitrile, trifluorobenzonitrile, phenylacetonitrile, 2-fluorophenylacetonitrile, 4-fluorophenylacetonitrile, ethylene glycol bis(2-cyanoethyl)ether (ASA3), 1,3,6-hexanetricarbonitrile (HTCN), 1,4-dicyano-2-butene (DCB), or 1,2,3-tris(2-cyanoethyl)propane (TCEP).

The amine-based compound may be at least one selected from triethanolamine or ethylenediamine, and the silane-based compound may be tetravinylsilane.

The benzene-based compound may be at least one selected from monofluorobenzene, difluorobenzene, trifluorobenzene, or tetrafluorobenzene.

The lithium salt-based compound is a compound different from the lithium salt included in the non-aqueous electrolyte solution, and may be at least one compound selected from among difluoro phosphate (LiDFP; LiPO₂F₂), lithium bisoxalatoborate (LiBOB; LiB(C₂O₄)₂), lithium tetrafluoroborate (LiBF₄), lithium tetraphenylborate, or lithium difluoro(bisoxalato)phosphate (LiDFOP).

Meanwhile, the content of the fourth additive may be 0.1 wt % to 5 wt % based on the total weight of the non-aqueous electrolyte solution. When the additive content is within the above range, there is an effect of suppressing side reactions through the formation of the films on the positive electrode and the negative electrode.

### (3) Organic Solvent

In one embodiment, the non-aqueous electrolyte solution of the present invention includes an organic solvent.

Various organic solvents typically used in a lithium electrolyte may be used as the organic solvent without limitation. For example, the organic solvent may be a cyclic carbonate-based solvent, a linear carbonate-based solvent, a linear ester-based solvent, a cyclic ester-based solvent, a nitrile-based solvent, or a mixture thereof, and may preferably include a mixture of a cyclic carbonate-based solvent and a linear carbonate-based solvent.

The cyclic carbonate-based solvent is a highly viscous organic solvent which may well dissociate the lithium salt in the electrolyte due to high permittivity, and may be at least one selected from the group consisting of ethylene carbonate (EC), propylene carbonate (PC), 1,2-butylene carbonate, 2,3-butylene carbonate, 1,2-pentylene carbonate, 2,3-pentylene carbonate, and vinylene carbonate, and may preferably include ethylene carbonate (EC).

In addition, the linear carbonate-based solvent is an organic solvent having low viscosity and low permittivity, and may be at least one selected from the group consisting of dimethyl carbonate (DMC), diethyl carbonate (DEC), dipropyl carbonate, ethyl methyl carbonate (EMC), methylpropyl carbonate, and ethylpropyl carbonate, and preferably, may include ethyl methyl carbonate (EMC).

In order to prepare an electrolyte having high ionic conductivity, it is desirable to use a mixture of the cyclic carbonate-based solvent and the linear carbonate-based solvent as the organic solvent.

The linear ester-based solvent may be at least one selected from among methyl acetate, ethyl acetate, propyl acetate, methyl propionate, ethyl propionate, propyl propionate, or butyl propionate, and may preferably be methyl propionate, ethyl propionate, or propyl propionate.

The cyclic ester-based solvent may be at least one selected from among γ-butyrolactone, γ-valerolactone, γ-caprolactone, δ-valerolactone, or ε-caprolactone.

The nitrile-based solvent may be at least one selected from among succinonitrile, acetonitrile, propionitrile, butyronitrile, valeronitrile, caprylonitrile, heptanenitrile, cyclopentane carbonitrile, cyclohexane carbonitrile, 2-fluorobenzonitrile, 4-fluorobenzonitrile, difluorobenzonitrile, trifluorobenzonitrile, phenylacetonitrile, 2-fluorophenylacetonitrile, or 4-fluorophenylacetonitrile, and may preferably be succinonitrile.

Remainders except for the amounts of the other components except for the organic solvent, for example, the compound represented by Formula 1 above, the additive, and the lithium salt in the total weight of the non-aqueous electrolyte may all be organic solvents unless otherwise stated.

### (4) Lithium Salt

In one embodiment, the non-aqueous electrolyte solution of the present invention includes a lithium salt.

Any lithium salt typically used in an electrolyte solution for a lithium secondary battery may be used as the lithium salt without limitation, and specifically, the lithium salt may include Li⁺ as a cation, and may include at least one selected from among F⁻, Cl⁻, Br⁻, I⁻, NO₃⁻, N(CN)₂⁻, BF₄⁻, ClO₄⁻, B₁₀Cl₁₀⁻, AlCl₄⁻, AlO₄⁻, PF₆⁻, CF₃SO₃⁻, CH₃CO₂⁻, CF₃CO₂⁻, AsF₆⁻, SbF₆⁻, CH₃SO₃⁻, (CF₃CF₂SO₂)₂N⁻, (CF₃SO₂)₂N⁻, (FSO₂)₂N⁻, BF₂C₂O₄⁻, BC₄O₈⁻, BF₂C₂O₄CHF⁻, PF₄C₂O₄⁻, PF₂C₄O₈⁻, PO₂F₂⁻, (CF₃)₂PF₄⁻, (CF₃)₃PF₃⁻, (CF₃)₄PF₂⁻, (CF₃)₅PF⁻, (CF₃)₆P⁻, C₄F₉SO₃⁻, CF₃CF₂SO₃⁻, CF₃CF₂(CF₃)₂CO⁻, (CF₃SO₂)₂CH⁻, CF₃(CF₂)₇SO₃⁻, or SCN⁻ as an anion.

Specifically, the lithium salt may be at least one selected from among LiPF₆, LiClO₄, LiBF₄, LiN(FSO₂)₂(LiFSI), LiTFSI, lithium bis(pentafluoroethanesulfonyl)imide (LiBETI), LiSO₃CF₃, LiPO₂F₂, lithium bis(oxalate) borate (LiBOB), lithium difluoro(oxalate)borate (LiFOB), lithium difluoro(bisoxalato) phosphate (LiDFOP), lithium tetrafluoro(oxalate) phosphate (LiTFOP), or lithium fluoromalonato(difluoro) borate (LiFMDFB), and may preferably be LiPF₆.

In an embodiment of the present invention, a concentration of the lithium salt in the non-aqueous organic solution containing the lithium salt and the organic solvent may be 0.5 M to 4.0 M, preferably, 0.5 M to 3.0 M, and more preferably, 0.8 M to 2.0 M. When the concentration of the lithium salt is within the above range, the effects of improving low-temperature output and cycle characteristics are sufficiently secured, and the viscosity and surface tension are prevented from being excessively increased, thereby obtaining appropriate electrolyte solution wetting.

### Positive Electrode

In one embodiment, the lithium secondary battery according to the present invention includes a positive electrode including a positive electrode active material containing a lithium composite transition metal oxide including nickel, cobalt, and manganese.

Specifically, the lithium composite transition metal oxide may include nickel of 70 mol % or more, preferably 80 mol % or more, and more preferably 85 mol % or more, based on the total number of moles of the transition metals.

In the case of the lithium composite transition metal oxide including nickel, cobalt, and manganese, there is a limitation that the chemical/electrochemical reaction is accelerated at the interface between the electrode and the electrolyte solution due to an unstable structure, and thus components of the electrolyte solution are important in order to improve the limitation.

In particular, in the case of a high-Ni positive electrode active material, structural collapse occurs easily at a high voltage, and in this process, active material particles are broken and reactive oxygen species are generated, and the decomposition reaction of the electrolyte solution is intensified due to the reaction between the generated reactive oxygen species and the electrolyte solution.

In the case of the lithium secondary battery according to the present disclosure, as described above, the decomposition reaction of the electrolyte solution generated at the interface with the electrode may be controlled through the non-aqueous electrolyte solution containing the first additive and the second additive, thereby improving the decomposition reaction.

In an embodiment of the present invention, the lithium composite transition metal oxide may be represented by Formula 3 below:

Li₁₊ₓ(NiₐCo_{b}Mn_{c}M_{d})O₂ [Formula 3]

In Formula 3 above,
M is at least one selected from the group consisting of W, Cu, Fe, V, Cr, Ti, Zr, Zn, Al, In, Ta, Y, La, Sr, Ga, Sc, Gd, Sm, Ca, Ce, Nb, Mg, B, and Mo, and
x, a, b, c, and d each satisfy −0.2≤x≤0.2, 0.70≤a<1, 0<b≤0.25, 0<c≤0.25, 0≤d≤0.1, and a+b+c+d=1.

Preferably, a, b, c, and d in Formula 3 above may satisfy 0.80≤a<1, 0<b≤0.15, 0<c≤0.15, and 0≤d≤0.05, respectively, more preferably, 0.85≤a≤0.95, 0.025≤b≤0.1, 0.025≤c≤0.1, and 0≤d≤0.05, respectively.

In an embodiment of the present invention, M in Formula 3 above may be Al, which is favorable for the stability.

The positive electrode according to the present disclosure may be prepared by coating a positive electrode collector with a positive electrode slurry containing a positive electrode active material, a binder, a conductive agent, a solvent, etc., and then drying and rolling the coated positive electrode collector.

The positive electrode collector is not particularly limited so long as it has conductivity without causing adverse chemical changes in the battery, and, for example, stainless steel; aluminum; nickel; titanium; sintered carbon; or aluminum or stainless steel of which the surface is treated with carbon, nickel, titanium, silver, or the like may be used.

The positive electrode active material may be included in an amount of 80 wt % to 99 wt %, specifically, 90 wt % to 99 wt % based on the total weight of the solid content in the positive electrode slurry. In this case, when the amount of the positive electrode active material is 80 wt % or less, since energy density is reduced, capacity may be reduced.

The binder is a component that assists in the binding between the active material and the conductive agent and in the binding with the current collector, and may be commonly added in an amount of 1 wt % to 30 wt % based on the total weight of the solid content in the positive electrode slurry. Examples of the binder may be polyvinylidene fluoride, polyvinyl alcohol, carboxymethylcellulose (CMC), starch, hydroxypropylcellulose, regenerated cellulose, polyvinylpyrrolidone, polytetrafluoroethylene, polyethylene, polypropylene, an ethylene-propylene-diene monomer, a sulfonated ethylene-propylene-diene monomer, a styrene-butadiene rubber, a fluoro rubber, or various copolymers thereof.

In addition, the conductive agent is a material providing conductivity without causing adverse chemical changes in the battery, and may be added in an amount of 0.5 wt % to 20 wt % based on the total weight of the solid content in the positive electrode slurry.

For example, the conductive agent may be selected from among carbon black such as acetylene black, Ketjen black, channel black, furnace black, lamp black, or thermal black; graphite powder such as natural graphite, artificial graphite, carbon nanotubes, or graphite; conductive fibers such as carbon fibers or metal fibers; conductive powder such as fluorocarbon powder, aluminum powder, or nickel powder; conductive whiskers such as zinc oxide whiskers or potassium titanate whiskers; conductive metal oxide such as titanium oxide; a conductive material such as polyphenylene derivatives; or a combination thereof.

Furthermore, the solvent of the positive electrode slurry may include an organic solvent, such as N-methyl-2-pyrrolidone (NMP), and may be used in an amount such that desirable viscosity is obtained when the positive electrode active material, the binder, and the conductive agent are included. For example, the solvent may be included in an amount such that a concentration of the solid content in the positive electrode slurry containing the positive electrode active material, the binder, and the conductive agent is 40 wt % to 90 wt %, preferably, 50 wt % to 80 wt %.

### Negative Electrode

In one embodiment, the lithium secondary battery according to the present invention includes a negative electrode including a negative electrode active material, and the negative electrode may be prepared by coating a negative electrode collector with a negative electrode slurry including the negative electrode active material, a binder, a conductive agent, a solvent, etc., and then drying and rolling the coated negative electrode collector.

The negative electrode collector generally has a thickness of 3 μm to 500 μm. The negative electrode collector is not particularly limited so long as it has high conductivity without causing adverse chemical changes in the battery, and, for example, copper; stainless steel; aluminum; nickel; titanium; sintered carbon; copper or stainless steel of which the surface is treated with carbon, nickel, titanium, silver, or the like; or an aluminum-cadmium alloy may be used. Also, like the positive electrode collector, the negative electrode collector may have fine surface roughness to improve binding strength with the negative electrode active material, and the negative electrode collector may be used in various shapes such as a film, a sheet, a foil, a net, a porous body, a foam body, and a non-woven fabric body.

In an embodiment of the present invention, the negative electrode active material may include a silicon-based material.

The silicon-based material is at least one selected from among Si, SiOₓ (0<x<2), or a Si—Y alloy (Y is an element selected from among an alkali metal, an alkaline earth metal, a Group 13 element, a Group 14 element, a transition metal, a rare earth element, or a combination thereof, and cannot be Si), and preferably Si. The element Y may be selected from the group consisting of Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ge, P, As, Sb, Bi, S, Se, Te, Po, and a combination thereof. Si has an advantage of having a theoretical capacity higher than SiOₓ.

The capacity of the silicon-based negative electrode active material is about 10 times higher than that of graphite, and thus mass loading (mg·cm⁻²) is lowered, thereby improving fast charging performance of the battery. However, there is a limitation in that the lithium ion loss rate due to the irreversible reaction is high and the volume change is large, thereby adversely affecting the life, and this limitation may be solved by applying the above-described non-aqueous electrolyte solution. Specifically, in the case of the negative electrode containing a silicon-based negative electrode active material, particularly, the negative electrode containing 100% of Si, there is a limitation in that the SEI film is easily broken and regenerated, which occurs continuously, due to large changes in volume during a charging and discharging process as compared with a negative electrode containing a carbon-based negative electrode active material. If the non-aqueous electrolyte solution according to the present disclosure is applied, the SEI film can be strengthened as described above, thereby effectively solving such a limitation.

In an embodiment of the present invention, the silicon-based material may be 70 wt % to 100 wt %, preferably, 80 wt % to 100 wt % based on the total weight of the negative electrode active material, and more preferably, the negative electrode active material may be made from a silicon-based material. When the silicon-based material is included in the above range, there are effects of increasing the capacity of the negative electrode and improving the fast charging performance.

In addition, in a preferred embodiment, the negative electrode active material may be made from only Si, that is, pure Si.

Furthermore, the negative electrode active material may include at least one selected from a carbon material capable of reversibly intercalating/deintercalating lithium ions; metal or an alloy of lithium and the metal; a metal composite oxide; a material which may be undoped and doped with lithium; lithium metal; or a transition metal oxide, in addition to the silicon-based material.

As the carbon material capable of reversibly intercalating/deintercalating lithium ions, a carbon-based negative electrode active material generally used in a lithium ion secondary battery may be used without particular limitation, and, as a typical example, crystalline carbon, amorphous carbon, or both thereof may be used. Examples of the crystalline carbon may include graphite such as irregular, planar, flaky, spherical, or fibrous natural graphite or artificial graphite, and examples of the amorphous carbon may include soft carbon (low-temperature sintered carbon), hard carbon, mesophase pitch carbide, or sintered cokes.

As the metal or the alloy of lithium and the metal, a metal selected from the group consisting of copper (Cu), nickel (Ni), sodium (Na), potassium (K), rubidium (Rb), cesium (Cs), francium (Fr), beryllium (Be), magnesium (Mg), calcium (Ca), strontium (Sr), silicon (Si), antimony (Sb), lead (Pb), indium (In), zinc (Zn), barium (Ba), radium (Ra), germanium (Ge), aluminum (Al), and tin (Sn), or an alloy of lithium and the metal may be used.

At least one selected from the group consisting of PbO, PbO₂, Pb₂O₃, Pb₃O₄, Sb₂O₃, Sb₂O₄, Sb₂O₅, GeO, GeO₂, Bi₂O₃, Bi₂O₄, Bi₂O₅, LiₓFe₂O₃ (0≤x≤1), LiₓWO₂ (0≤x≤1), and SnₓMe₁₋ₓMe′_{y}O_{z} (where, Me is Mn, Fe, Pb, or Ge; Me′ is Al, B, P, Si, Groups I, II or III elements of the periodic table, or halogen; 0<x≤1; 1≤y≤3; and 1≤z≤8) may be used as the metal composite oxide.

The material which may be doped and undoped with lithium may include Sn, SnO₂, Sn—Y′ (wherein Y′ above is an element selected from the group consisting of an alkali metal, an alkaline earth metal, a Group 13 element, a Group 14 element, a transition metal, a rare earth element, and a combination thereof, and is not Sn), or the like. The element Y′ may be selected from the group consisting of Mg, Ca, Sr, Ba, Ra, Sc, Y, Ti, Zr, Hf, Rf, V, Nb, Ta, Db (dubnium), Cr, Mo, W, Sg, Tc, Re, Bh, Fe, Pb, Ru, Os, Hs, Rh, Ir, Pd, Pt, Cu, Ag, Au, Zn, Cd, B, Al, Ga, Si, In, Ge, P, As, Sb, Bi, S, Se, Te, Po, and a combination thereof.

Examples of the transition metal oxide may include lithium-containing titanium composite oxide (LTO), vanadium oxide, lithium vanadium oxide, or the like.

The negative electrode active material may be included in an amount of 60 wt % to 99 wt % based on the total weight of the solid content in the negative electrode slurry.

The binder is a component that assists in the binding between the conductive agent, the active material, and the current collector, wherein the binder may commonly be added in an amount of 1 wt % to 30 wt % based on the total weight of the solid content in the negative electrode slurry. Examples of the binder may include polyvinylidene fluoride, polyvinyl alcohol, carboxymethylcellulose (CMC), starch, hydroxypropylcellulose, regenerated cellulose, polyvinylpyrrolidone, polytetrafluoroethylene, polyethylene, polypropylene, an ethylene-propylene-diene monomer, a sulfonated ethylene-propylene-diene monomer, a styrene-butadiene rubber, a fluoro rubber, various copolymers thereof, or the like.

The conductive agent is a component for further improving the conductivity of the negative electrode active material, and may be added in an amount of 0.5 wt % to 20 wt % based on the total weight of the solid content in the negative electrode slurry. Any conductive agent may be used without particular limitation so long as it has conductivity without causing adverse chemical changes in the battery, and, for example, carbon black such as acetylene black, Ketjen black, channel black, furnace black, lamp black, or thermal black; graphite powder such as natural graphite with a well-developed crystal structure, artificial graphite, carbon nanotubes, or graphite; conductive fibers such as carbon fibers or metal fibers; conductive powder such as fluorocarbon powder, aluminum powder, or nickel powder; conductive whiskers such as zinc oxide whiskers or potassium titanate whiskers; conductive metal oxide such as titanium oxide; a conductive material such as polyphenylene derivatives; or a combination thereof may be used.

The solvent of the negative electrode slurry may include water; or an organic solvent such as NMP or alcohol, and may be used in an amount such that desirable viscosity is obtained when the negative electrode active material, the binder, and the conductive agent are included. For example, the solvent may be included in an amount such that a concentration of the solid content in the negative electrode slurry including the negative electrode active material, the binder, and the conductive agent is in a range of 30 wt % to 80 wt %, preferably, 40 wt % to 70 wt %.

### Separator

In one embodiment, the lithium secondary battery according to the present invention includes a separator between the positive electrode and the negative electrode.

The separator separates the negative electrode and the positive electrode and provides a movement path of lithium ions, and any separator may be used as the separator without particular limitation as long as it is typically used in a lithium secondary battery, and particularly, a separator having excellent wettability of the electrolyte and excellent stability as well as low resistance to the transfer of electrolyte ions is preferable.

Specifically, a porous polymer film, for example, a porous polymer film prepared from a polyolefin-based polymer, such as an ethylene homopolymer, a propylene homopolymer, an ethylene/butene copolymer, an ethylene/hexene copolymer, and an ethylene/methacrylate copolymer; or a laminated structure having two or more layers thereof may be used as the separator. Also, a typical porous nonwoven fabric, for example, a nonwoven fabric formed of high melting point glass fibers or polyethylene terephthalate fibers may be used. Furthermore, a coated separator including a ceramic component or a polymer material may be used to secure heat resistance or mechanical strength, and the separator having a single layer or multilayer structure may be used.

The lithium secondary battery according to the present disclosure as described above may be useful for portable devices, such as mobile phones, notebook computers, and digital cameras, electric cars such as hybrid electric vehicles (HEVs), and the like.

Thus, according to another embodiment of the present invention, a battery module including the lithium secondary battery as a unit cell and a battery pack including the battery module are provided.

The battery module or the battery pack may be used as a power source of at least one medium and large sized device of a power tool; electric cars including an electric vehicle (EV), a hybrid electric vehicle, or a plug-in hybrid electric vehicle (PHEV); or a power storage system.

A shape of the lithium secondary battery of the present disclosure is not particularly limited, but a cylindrical type using a can, a prismatic type, a pouch type, or a coin type may be used.

The lithium secondary battery according to the present disclosure may not only be used in a battery cell that is used as a power source of a small device, but may also be preferably used as a unit cell in a medium-and-large-sized battery module including a plurality of battery cells.

Hereinafter, the present disclosure will be described in detail with reference to specific examples.

### EXAMPLES

### Example 1

### (Preparation of Non-Aqueous Electrolyte)

A non-aqueous organic solution was prepared by mixing ethylene carbonate (EC) and ethyl methyl carbonate (EMC) in a volume ratio of 30:70 and then dissolving LiPF₆ in the mixture so as for the LiPF₆ to have a concentration of 1.0 M. A non-aqueous electrolyte solution (100 wt %) was prepared by mixing 0.5 wt % of LiSO₃CF₃, 0.3 wt % of the compound represented by Formula 2A above, 0.5 wt % of vinylene carbonate (VC), and the balance of the non-aqueous organic solution.

### (Manufacture of Lithium Secondary Battery)

LiNi_{0.86}Co_{0.05}Mn_{0.07}Al_{0.02}O₂ as a positive electrode active material, a conductive agent (carbon black), and a binder (polyvinylidene fluoride) were added in a weight ratio of 97.6:0.8:1.6 into N-methyl-2-pyrrolidone (NMP), thereby preparing a positive electrode slurry (solid content: 60 wt %). A 13.5 μm thick aluminum (Al) thin film, as a positive electrode collector, was coated with the positive electrode slurry, dried, and then roll-pressed, thereby preparing a positive electrode.

A negative electrode active material (100 wt % of Si), a conductive agent (super-C), and a binder (styrene-butadiene rubber) were added in a weight ratio of 70:20:10 into water, as a solvent, thereby preparing a negative electrode slurry (solid content: 60 wt %). A 6 μm-thick copper (Cu) thin film, as a negative electrode collector, was coated with the negative electrode slurry, dried, and then roll-pressed, thereby preparing a negative electrode.

An electrode assembly was prepared by sequentially stacking the positive electrode, a polyolefin-based porous separator coated with inorganic particles (Al₂O₃), and the negative electrode.

The electrode assembly was accommodated in a pouch-type battery case, and the prepared non-aqueous electrolyte was injected thereinto, thereby manufacturing a lithium secondary battery.

### Example 2

A lithium secondary battery was manufactured in the same manner as in Example 1, except that the content of LiSO₃CF₃ was changed to 3 wt % during the preparation of the non-aqueous electrolyte solution.

### Example 3

A lithium secondary battery was manufactured in the same manner as in Example 1, except that LiSO₃C₄F₉ was used instead of LiSO₃CF₃ during the preparation of the non-aqueous electrolyte solution.

### Example 4

A lithium secondary battery was manufactured in the same manner as in Example 2, except that LiSO₃C₄F₉ was used instead of LiSO₃CF₃ during the preparation of the non-aqueous electrolyte solution.

### Comparative Example 1

A lithium secondary battery was manufactured in the same manner as in Example 1, except that LiSO₃CF₃ was not added and LiCoO₂ was used instead of LiNi_{0.86}Co_{0.05}Mn_{0.07}Al_{0.02}O₂ as a positive electrode active material during the preparation of the non-aqueous electrolyte solution.

### Comparative Example 2

A lithium secondary battery was manufactured in the same manner as in Example 1, except that LiSO₃CF₃ was not added during the preparation of the non-aqueous electrolyte solution.

### Comparative Example 3

A lithium secondary battery was prepared in the same manner as in Example 1, except that the compound represented by Formula 2A was not added during the preparation of the non-aqueous electrolyte solution.

### Comparative Example 4

A lithium secondary battery was prepared in the same manner as in Example 3, except that the compound represented by Formula 2A was not added during the preparation of the non-aqueous electrolyte solution.

### EXPERIMENTAL EXAMPLES

### Experimental Example 1: Evaluation of High-Temperature (45° C.) Life Characteristics

After each of the lithium secondary batteries manufactured in Examples and Comparative Examples was activated at a CC of 0.1 C, degassing was performed.

Thereafter, each secondary battery was charged at a CC of 0.33 C to 3.6 V under a constant current-constant voltage (CC-CV) condition at 25° C., then subjected to 0.05 C current cut-off, and discharged at a CC of 0.33 C to 2.5 V. Next, each secondary battery was charged at a CC of 0.33 C to 3.6 V under a constant current-constant voltage (CC-CV) condition at 45° C., then subjected to 0.05 C current cut-off, and discharged at a CC of 0.33 C to 2.5 V.

The above charge and discharge were set as one cycle, and charge and discharge were performed at a high temperature (45° C.), and discharge capacity and resistance were measured after each of 1 cycle and 300 cycles using charge/discharge equipment (5 V, 6 A).

The measured discharge capacity and resistance were put into Equation 1 and Equation 2 below, respectively, thereby calculating capacity retention and resistance increase rate, and the results thereof are listed in Table 1 below.

A volume increase rate was calculated by putting, into Equation 3 below, volumes measured by a buoyancy method after 1 cycle and 300 cycles.

$$Capacity retention ( \% ) = ( discharge capacity after 300 cycles / discharge capacity after 1 cycle ) \times 100 \qquad [ Equation 1 ]$$

$$Resistance increase rate ( \% ) = \{ ( resistance after 300 cycles - resistance after 1 cycle ) \text{} / resistance after 1 cycle \} \times 100 \qquad [ Equation 2 ]$$

$$Volume increase rate ( \% ) = \{ ( volume after 300 cycles - volume after 1 cycle ) \text{} / volume after 1 cycle \} \times 100 \qquad [ Equation 3 ]$$

TABLE 1

| | | | | Second | Experimental Example 1 | | |
|---|---|---|---|---|---|---|---|
| | Positive | First | | additive | | Resistance | Volume |
| | Electrode | additive | | Content of | Capacity | increase | increase |
| | Active | R in | Content | Formula 2A | retention | rate | rate |
| | Material | Formula 1 | (wt %) | (wt %) | (%) | (%) | (%) |
| Example 1 | NCMA | CF₃ | 0.5 | 0.3 | 95.50 | 3.30 | 2.80 |
| Example 2 | NCMA | CF₃ | 3 | 0.3 | 97.10 | 1.20 | 1.90 |
| Example 3 | NCMA | C₄F₉ | 0.5 | 0.3 | 96.20 | 1.90 | 2.30 |
| Example 4 | NCMA | C₄F₉ | 3 | 0.3 | 95.80 | 2.20 | 2.70 |
| Comparative | LCO | — | — | 0.3 | 82.50 | 15.40 | 14.50 |
| Example 1 | | | | | | | |
| Comparative | NCMA | — | — | 0.3 | 83.40 | 10.30 | 12.10 |
| Example 2 | | | | | | | |
| Comparative | NCMA | CF₃ | 0.5 | — | 81.24 | 17.65 | 20.57 |
| Example 3 | | | | | | | |
| Comparative | NCMA | C₄F₉ | 0.5 | — | 82.36 | 16.55 | 18.65 |
| Example 4 | | | | | | | |

From the results of Table 1 above, it may be confirmed that the batteries of Examples 1 to 4 using the electrolyte solution containing both the first additive represented by Formula 1 and the second additive represented by Formula 2 exhibit excellent performance in which the capacity retention rate at high temperatures is 95% or more, and both the resistance increase rate and the volume increase rate are 5% or less even though the batteries include a high-nickel positive electrode active material and a Si negative electrode. On the other hand, it may be confirmed that the batteries of Comparative Examples 1 and 2 using the electrolyte solution without containing the first additive and the batteries of Comparative Examples 3 and 4 using the electrolyte solution without containing the second additive have a significant deterioration in all of capacity retention, resistance increase rate, and volume increase rate as compared with the batteries of Examples 1 to 4.

That is, it may be seen that when both the first additive and the second additive are included, there is a great effect on improving the high-temperature performance of the lithium secondary battery.

### Experimental Example 2: Evaluation of Fast Charging Performance

After a lithium secondary battery having a state of charge (SOC) of 8% in each of the lithium secondary batteries manufactured in the Examples and Comparative Examples was prepared, charging was performed at 25° C. while changing C-rate according to the SOC state as shown in Table 2 below, and voltage profiles were determined by checking voltage values at 1 second intervals for each charging section.

TABLE 2

| | Charging Time (sec) | C-rate (C) |
|---|---|---|
| SOC 8%-61% | 880 | 2.5 |
| SOC 62%-80% | 620 | 1 |

Thereafter, the amount of charge when each battery was charged in the CC mode by setting an end condition with the voltage value for each section obtained in each section was recorded. Then, each battery was discharged to a SOC of 8% at 0.5 C in the CC mode again. The charging and discharging was set as 1 cycle, 300 cycles were performed, and then the capacity retention, the resistance increase rate, and the volume increase rate were calculated in the same manner as in Experimental Example 1 above, and the results are listed in Table 3 below.

TABLE 3

| | | | | Second | Experimental Example 2 | | |
|---|---|---|---|---|---|---|---|
| | Positive | First | | additive | | Resistance | Volume |
| | Electrode | additive | | Content of | Capacity | increase | increase |
| | Active | R in | Content | Formula 2A | retention | rate | rate |
| | Material | Formula 1 | (wt %) | (wt %) | (%) | (%) | (%) |
| Example 1 | NCMA | CF₃ | 0.5 | 0.3 | 91.20 | 5.20 | 5.50 |
| Example 2 | NCMA | CF₃ | 3 | 0.3 | 94.20 | 3.50 | 3.40 |
| Example 3 | NCMA | C₄F₉ | 0.5 | 0.3 | 93.60 | 4.80 | 4.80 |
| Example 4 | NCMA | C₄F₉ | 3 | 0.3 | 92.40 | 5.10 | 5.30 |
| Comparative | LCO | — | — | 0.3 | 75.40 | 20.40 | 25.40 |
| Example 1 | | | | | | | |
| Comparative | NCMA | — | — | 0.3 | 79.20 | 18.90 | 23.10 |
| Example 2 | | | | | | | |
| Comparative | NCMA | CF₃ | 0.5 | — | 70.65 | 26.75 | 30.11 |
| Example 3 | | | | | | | |
| Comparative | NCMA | C₄F₉ | 0.5 | — | 72.43 | 24.12 | 27.45 |
| Example 4 | | | | | | | |

From the results of Table 3 above, it may be confirmed that the batteries of Examples 1 to 4 using the electrolyte solution containing both the first additive represented by Formula 1 and the second additive represented by Formula 2 have also excellent performance in the quick charging condition even though the batteries include a high-nickel positive electrode active material and a Si negative electrode, as compared with the batteries of Comparative Examples 1 to 4.

On the other hand, it may be confirmed that the batteries of Comparative Examples 1 and 2 using the electrolyte solution without containing the first additive and the batteries of Comparative Examples 3 and 4 using the electrolyte solution without containing the second additive have a significant decrease in all of capacity retention, resistance increase rate, and volume increase rate as compared with the batteries of Examples 1 to 4.

Thus, it is confirmed that only the case of containing both the first additive and the second additive can achieve the effect of the present disclosure.

1. A lithium secondary battery comprising:
a non-aqueous electrolyte solution containing a lithium salt, an organic solvent, a first additive represented by Formula 1, and a second additive represented by Formula 2;
a positive electrode comprising a positive electrode active material containing a lithium composite transition metal oxide comprising nickel, cobalt, and manganese;
a negative electrode comprising a negative electrode active material; and
a separator interposed between the positive electrode and the negative electrode:
LiSO₃R [Formula 1]
in Formula 1,
R is an alkyl group having 1 to 10 carbon atoms and being unsubstituted or substituted with fluorine, and 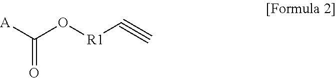
in Formula 2,
A is a heterocyclic group having 3 to 5 carbon atoms, or a heteroaryl group having 3 to 5 carbon atoms, and
R1 is an alkylene group having 1 to 3 carbon atoms.

2. The lithium secondary battery of claim 1, wherein R in Formula 1 is CₙF₂ₙ₊₁, and n is an integer of 1 to 5.

3. The lithium secondary battery of claim 1, wherein A in Formula 2 is a nitrogen-containing heterocyclic group having 3 to 5 carbon atoms or a nitrogen-containing heteroaryl group having 3 to 5 carbon atoms.

4. The lithium secondary battery of claim 1, wherein the non-aqueous electrolyte solution further comprises at least one third additive selected from vinylene carbonate or vinyl ethylene carbonate.

5. The lithium secondary battery of claim 1, wherein a content of the first additive is 0.1 wt % to 5 wt % based on a total weight of the non-aqueous electrolyte solution.

6. The lithium secondary battery of claim 1, wherein a content of the second additive is 0.01 wt % to 2 wt % based on a total weight of the non-aqueous electrolyte solution.

7. The lithium secondary battery of claim 1, wherein the organic solvent comprises a mixture of a cyclic carbonate-based solvent and a linear carbonate-based solvent.

8. The lithium secondary battery of claim 1, wherein the lithium composite transition metal oxide contains 70 mol % or more of nickel based on a total number of moles of transition metals.

9. The lithium secondary battery of claim 1, wherein the lithium composite transition metal oxide is represented by Formula 3:
Li₁₊ₓ(NiₐCo_{b}Mn_{c}M_{d})O₂ [Formula 3]
in Formula 3,
M is at least one selected from the group consisting of W, Cu, Fe, V, Cr, Ti, Zr, Zn, Al, In, Ta, Y, La, Sr, Ga, Sc, Gd, Sm, Ca, Ce, Nb, Mg, B, and Mo, and
x, a, b, c, and d each satisfy −0.2≤x≤0.2, 0.70≤a<1, 0<b≤0.25, 0<c≤0.25, 0≤d≤0.1, and a+b+c+d=1.

10. The lithium secondary battery of claim 9, wherein a, b, c, and d in Formula 3 satisfy 0.80≤a<1, 0<b≤0.15, 0<c≤0.15, and 0≤d≤0.05, respectively.

11. The lithium secondary battery of claim 1, wherein the negative electrode active material comprises a silicon-based material.

12. The lithium secondary battery of claim 1, wherein the first additive is LiSO₃CₙF₂ₙ₊₁ and n is an integer of 3 or less, and a content of the first additive is 2 wt % to 4 wt % based on a total weight of the non-aqueous electrolyte solution.

13. The lithium secondary battery of claim 1, wherein the first additive is LiSO₃CₙF₂ₙ₊₁ and n is an integer of 4 or greater, and a content of the first additive is 0.1 wt % to 1 wt % based on a total weight of the non-aqueous electrolyte solution.

14. The lithium secondary battery of claim 1, wherein the second additive is represented by Formula 2-1: 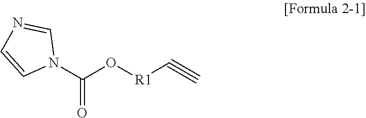
in Formula 2-1,
R1 is the same as defined in Formula 2.

15. The lithium secondary battery of claim 1, wherein the second additive is represented by Formula 2A:

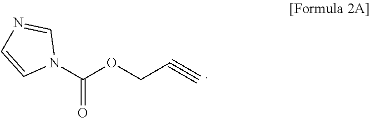

16. The lithium secondary battery of claim 4, wherein a content of the third additive is 0.01 wt % to 3 wt %, based on a total weight of the non-aqueous electrolyte solution.

17. The lithium secondary battery of claim 9, wherein M in Formula 3 is Al.

18. The lithium secondary battery of claim 11, wherein the silicon-based material is at least one selected from Si, SiOₓ (0<x<2), or a Si—Y alloy, wherein Y is an element selected from an alkali metal, an alkaline earth metal, a Group 13 element, a Group 14 element, a transition metal, a rare earth element, or a combination thereof, and is not Si.
